(19) United States
(12) Patent Application Publication
(10) Pub. No.: US 2023/0039481 A1
(43) Pub. Date: Feb. 9, 2023

(54) Method of Providing Mobility Sharing Service and Apparatus for the Same

(71) Applicants: Hyundai Motor Company, Seoul (KR); Kia Corporation, Seoul (KR)

(72) Inventors: Jae Jun Ha, Hwaseong-si (KR); Young Jun Moon, Sejong-si (KR)

(73) Assignees: Hyundai Motor Company, Seoul (KR); Kia Corporation, Seoul (KR); Kia Corporation, Seoul (KR)

(21) Appl. No.: 17/857,769

(22) Filed: Jul. 5, 2022

(30) Foreign Application Priority Data
Aug. 3, 2021 (KR) 10-2021-0102022

(51) Int. Cl. B60W 50/00; B60W 40/08; B60W 40/02; G05D 1/02

(52) U.S. Cl. CPC B60W 50/0098; B60W 40/08; B60W 40/02; G05D 1/0291; B60W 2040/0827; B60W 2050/0083; B60W 2540/043; B60W 2540/229; B60W 2556/10; G05D 2201/0213

(57) ABSTRACT

An embodiment method of providing a mobility sharing service includes generating initial control information of a shared mobility in correspondence with an identified user, monitoring driving environment information, generating a driving environment change event based on the driving environment information, and generating control information of the shared mobility based on the driving environment change event.

### CROSS-REFERENCE TO RELATED APPLICATIONS

This application claims the benefit of Korean Patent Application No. 10-2021-0102022, filed on Aug. 3, 2021, which application is hereby incorporated herein by reference.

### TECHNICAL FIELD

The present disclosure relates to a method and apparatus for providing a mobility sharing service.

### BACKGROUND

As technology advances, the concept of vehicle ownership has been weakened and use of shared mobilities has increased. Specifically, although the need to share mobilities such as car sharing or carpooling is increasing, the existing shared mobilities do not reflect diverse tendencies of individual users. Therefore, a personal interaction system of a user may be required.

In addition, mobilities are shared in a specific area or residence for convenience of life, and the need to receive services using them is increasing. However, in the case of sharing a mobility, satisfaction with the service is not high compared to a privately owned vehicle. Since a mobility sharing system is not properly established, it may be difficult to provide vehicle security and service. Hereinafter, a vehicle fleet system will be provided in consideration of the foregoing.

### SUMMARY

Embodiments of the present disclosure may provide a method and apparatus for providing a mobility sharing service through a fleet system.

Embodiments of the present disclosure may provide a method and apparatus capable of realizing vehicle control according to various contexts which may occur when using a shared vehicle, while reflecting vehicle usage tendency of an individual user through a fleet system.

According to an embodiment of the present disclosure, provided is a method of providing a mobility sharing service. The method may include checking a context control mode, monitoring driving environment information based on the context control mode, generating a driving environment change event based on the driving environment information, monitoring user information based on the context control mode, generating a user information change event based on the user information, and generating control information of a shared vehicle based on the driving environment change event or the user information change event.

The method may include monitoring user information and generating a user information change event based on the user information.

The generating the control information of the shared mobility may include generating control information of the shared mobility based on at least one of the driving environment change event or the user information change event.

The method may further include checking a context control mode.

The context control mode may include at least one of a driving environment priority mode in which control is performed by preferentially considering the driving environment information or user information priority mode in which control is performed by preferentially considering the user information.

In the method, in response to determining that the context control mode is the driving environment priority mode, a process of monitoring the driving environment information may be preferentially performed.

In response to a driving environment change event being generated based on the driving environment information, the control information of the shared mobility may be generated.

In response to a driving environment change event not being generated based on the driving environment information, a process of monitoring the user information may be performed.

In response to a user information change event being generated based on the user information, the control information of the shared mobility may be generated.

In response to determining that the context control mode is the user information priority mode, a process of monitoring the user information may be preferentially performed.

In the method, in response to a user information change event being generated based on the user information, the control information of the shared mobility may be generated.

In the method, in response to a user information change event not being generated based on the user information, a process of monitoring the driving environment information may be performed.

In the method, in response to a driving environment change event being generated based on the driving environment information, the control information of the shared mobility may be generated.

The generating the driving environment change event may include checking a first control value corresponding to a first context, checking a second control value corresponding to a second context, comparing the first control value with the second control value, and generating the driving environment change event according to a result of comparing the first control value with the second control value.

The generating the user information change event may include checking a first control value corresponding to a first context, checking a second control value corresponding to a second context, comparing the first control value with the second control value, and generating the user information change event according to a result of comparing the first control value with the second control value.

The driving environment information may include at least one of road surface type information, road surface state information, longitudinal linear information, transverse linear information, mobility distance, autonomous driving environment information, or driving time zone information.

The driving environment information may further include a road congestion level.

The driving environment information may further include size information of a road.

The user information may include at least one of a driver's fatigue degree, a driver's skill level, or a user's route familiarity level.

The monitoring the user information may include checking an initial fatigue degree when the user starts driving and checking at least one driving fatigue degree while the shared mobility is driven.

The monitoring the user information may include at least one of checking a change value between the initial fatigue degree and the at least one driving fatigue degree or checking a change value between a plurality of driving fatigue degrees.

The change value may include at least one of a change amount or a change rate.

According to another embodiment of the present disclosure, a mobility may be provided. The mobility may include a communication unit, at least one storage medium and at least one processor. The at least one processor may receive initial control information corresponding to an identified user from a server apparatus for managing a mobility sharing service, monitoring driving environment information, generating a driving environment change event based on the driving environment information, generating control information of the shared mobility based on the driving environment change event, and controlling the shared mobility based on the control information.

The at least one processor may monitor user information and generate a user information change event based on the user information.

The at least one processor may generate control information of the shared mobility based on at least one of the driving environment change event or the user information change event.

The at least one processor may check a context control mode and preferentially check at least one of the driving environment information or the user information according to the context control mode.

In response to determining that the context control mode is the driving environment priority mode, an operation of monitoring the driving environment information may be preferentially performed, and, in response to determining that the context control mode is the user information priority mode, an operation of monitoring the user information may be preferentially performed.

The at least one processor may check a first control value corresponding to a first context of the driving environment, check a second control value corresponding to a second context of the driving environment, compare the first control value with the second control value, and generate the driving environment change event according to a result of comparing the first control value with the second control value.

The at least one processor may check a first control value corresponding to a first context of the user information, check a second control value corresponding to a second context of the user information, compare the first control value with the second control value, and generate the user information change event according to a result of comparing the first control value with the second control value.

The mobility may further include at least one sensor device, and the driving environment information may include information detected through the at least one sensor device.

The at least one processor may receive the driving environment information from a server apparatus for managing at least one of road surface type information, road surface state information, longitudinal linear information, transverse linear information, or mobility distance.

The at least one processor may receive the driving environment information including a road congestion level from a server apparatus for managing the road congestion level.

The at least one processor may receive size information of a road from a server apparatus for managing the size information of the road.

The at least one processor may check an initial fatigue degree when the user starts driving and check at least one driving fatigue degree while the shared mobility is driven.

The at least one processor may check at least one of a change value between the initial fatigue degree and the at least one driving fatigue degree or a change value between a plurality of driving fatigue degrees.

The change value may include at least one of a change amount or a change rate.

The at least one processor may receive at least one of a driver's skill level or a user's route familiarity level from a server apparatus for managing the driver's skill level or the user's route familiarity level.

According to another embodiment of the present disclosure, a server apparatus provided in a mobility sharing system may be provided. The server apparatus may include a communication unit, at least one storage medium and at least one processor. The at least one processor may manage a user who uses a mobility sharing service, identify a user who requests use of a shared mobility, check initial control information of the identified user, and provide the initial control information to the shared mobility.

The at least one processor may receive the driving environment change event generated by the shared mobility, and store and manage the driving environment change event.

The at least one processor may receive the user information change event generated by the shared mobility, and store and manage the user information change event.

The at least one processor may check a context control mode for the identified user and provide the context control mode to the shared mobility.

According to embodiments of the present disclosure, it is possible to provide a mobility sharing service optimized for each user by reflecting a user's usage tendency in providing the mobility sharing service through a fleet system.

According to embodiments of the present disclosure, it is possible to provide a mobility sharing service for performing vehicle control according to various contexts which may occur when using a shared vehicle, while reflecting vehicle usage tendency of an individual user.

### BRIEF DESCRIPTION OF THE DRAWINGS

FIG. 1 is a view illustrating a method of, at a mobility, performing communication with another mobility or device through a network.

FIG. 2 is a view illustrating a method of providing a mobility sharing service based on a fleet system.

FIG. 3 is a flowchart illustrating a method of using a shared mobility using a fleet system according to an embodiment of the present disclosure.

FIG. 4 is a view illustrating a method of reflecting usage tendency of a user to a mobility based on a fleet system.

FIG. 5 is a view illustrating a method of collecting and learning driving tendency information in a fleet system.

FIGS. 6A and 6B are views illustrating driving environment information and user state information used in a method of providing a mobility sharing service according to an embodiment of the present disclosure.

FIG. 7 is a flowchart illustrating a method of providing a mobility sharing service according to an embodiment of the present disclosure.

FIG. 8 is a flowchart illustrating a method of providing a mobility sharing service according to another embodiment of the present disclosure.

FIGS. 9A to 9D are views illustrating an operation of generating a driving environment change event in a method of providing a mobility sharing service according to an embodiment of the present disclosure.

FIGS. 10A and 10B are views illustrating an operation of generating a user information change event in a method of providing a mobility sharing service according to an embodiment of the present disclosure.

FIG. 11 is a view illustrating the configuration of an apparatus according to an embodiment of the present disclosure.

### DETAILED DESCRIPTION OF ILLUSTRATIVE EMBODIMENTS

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with another element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an embodiment could be termed a second element in another embodiment, and, similarly, a second element in an embodiment could be termed a first element in another embodiment, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of embodiments of the present invention and the way of attaining them will become apparent with reference to exemplary embodiments described below in detail in conjunction with the accompanying drawings. Embodiments, however, may be embodied in many different forms and should not be constructed as being limited to example embodiments set forth herein. Rather, these embodiments are provided so that this disclosure will be complete and will fully convey the scope of the invention to those skilled in the art.

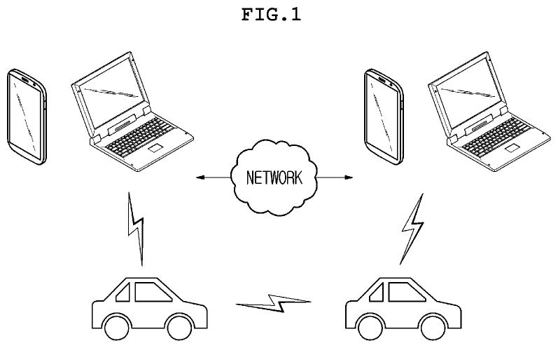

FIG. 1 is a view illustrating a moving object performing communication with another apparatus through a network.

Referring to FIG. 1, the moving object may perform communication with another moving object or another device. For example, the moving object may perform communication with another moving object or another device based on cellular communication, WAVE communication, dedicated short range communication (DSRC) or another communication method. That is, as the cellular communication network, a communication network such as LTE or 5G, a Wi-Fi communication network, a WAVE communication network, etc. may be used. In addition, a short-range communication network used in a moving object, such as DSRC, may be used, but the present disclosure is not limited to the above-described embodiment.

In addition, for example, in relation to communication of the moving object, for security of the moving object, a module capable of performing communication with a device located inside the moving object and a module capable of performing communication with a device located outside the moving object may be separately provided. For example, in the moving object, communication with only a device in a predetermined range in the moving object, such as Wi-Fi communication, may be performed based on security. For example, the moving object and the personal user terminal of the driver of the moving object may include communication modules for performing communication between each other. That is, the moving object and the personal user terminal of the driver of the moving object may use a communication network blocked from an external communication network. In addition, for example, the moving object may include a communication module for performing communication with an external device. In addition, for example, the above-described modules may be implemented as one module. That is, based on one module, the moving object may perform communication with another device, but the present disclosure is not limited to the above-described embodiments. That is, in the moving object, a communication method may be implemented based on various methods, but the present disclosure is not limited to the above-described embodiments.

In this case, the moving object may refer to a movable device, for example. For example, the moving object may include a vehicle (including an autonomous vehicle or an automated vehicle), a drone, a personal mobility, a mobile office, a mobile hotel or a personal air vehicle (PAV). The personal mobility may include, for example, a moving object including at least three wheels for stable independent traveling or a moving object which has one or two wheels but can be driven independently while maintaining balance (e.g., a single-wheel Segway, a two-wheel Segway, an electric kickboard, etc.). The personal mobility may use electricity using a battery as a power source, but is not limited thereto and may use any type of power source capable of moving the mobility. For example, the personal mobility may mean a means of transportation in which only one user rides or a means used by only one user. In addition, the personal mobility may mean a small means of transportation which may be used by a small number of users. For example, the personal mobility may include not only a single-wheel Segway, a two-wheel Segway and an electric kickboard but also an electric wheelchair, an electric bicycle and an electric two-wheeled vehicle. In addition, the moving object may include other moving devices and is not limited to the above-described embodiments.

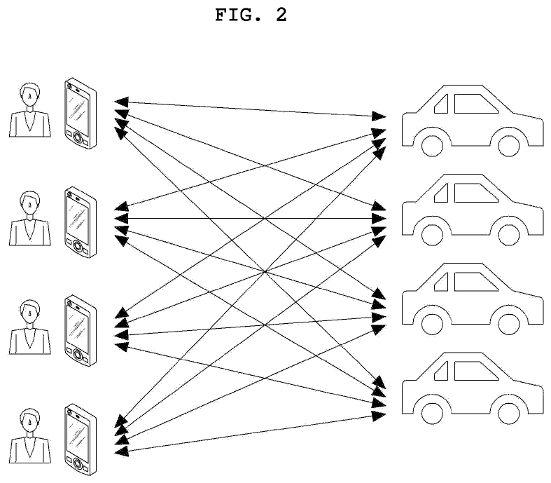

FIG. 2 is a view illustrating sharing a moving object based on a fleet system.

For example, a fleet system may be applied to provide a moving object sharing service. The fleet system may include, for example, at least one server, a plurality of user devices and a plurality of moving objects. The server may process a request of a user terminal, transmit a response message, process a reservation, process an assignment/return of a moving object according to the request, and manage the moving object, for a moving object sharing service (or a fleet service). In addition, the server may receive moving object state information from the moving object, generate overall state information of the moving object and perform overall management of information related to the moving object.

In addition, the fleet system may include a plurality of user terminals (or devices) and a plurality of moving objects. In addition, for example, the fleet system may further include a road side unit (RSU), etc.

The user devices may include a smartphone, a smart pad, a smart watch, etc. As another example, the user terminal may mean a device capable of exchanging signals through another communication means, but is not limited to the above-described embodiment. However, hereinafter, for convenience of description, this is referred to as a device or a user terminal.

The moving object may be a vehicle. In addition, for example, the moving object may be an object moving in a provided area such as a rail. As another example, the moving object may be a flying object such as a drone. That is, the moving object may refer to a movable object and may mean a moving object shared based on the fleet system. However, although the vehicle will be described below for convenience of description, this is equally applicable to the other moving objects.

As another example, the RSU is a road side unit and may be a device capable of performing communication. In addition, for example, the RSU may refer to a structure installed to transmit and receive signals to a building or another area and is not limited to the above-described embodiment. However, hereinafter, this will be collectively referred to as the RSU for convenience of description and may be various structures or devices and is not limited to the above-described embodiment.

In addition, the fleet system may be a moving object sharing system. The fleet system may be a system in which a moving object is shared in a predetermined area. The predetermined area may have the local concept such as an apartment complex or a work area. For example, the predetermined area may be an area in an apartment complex or an area separated from the apartment complex by a preset distance. As another example, the predetermined area may mean an area separated from a work area by a preset distance. As another example, an area to which the fleet system applies may be a larger area or a city unit, such as an administrative district, and is not limited to the above-described embodiment. That is, the predetermined area may mean a reference range in which operation based on the fleet system is possible, and may be changed by a user or a system.

In addition, for example, the fleet system may be a system in which the moving object is shared by users authenticated as specific users (or devices). For example, the specific user may be a resident of an apartment in a predetermined range in which the service of the fleet system may be provided or a worker of an office located in a specific area. For example, the specific user may be a person subscribing to the fleet system providable in a predetermined service area and may be a user outside the service area. Such a user may try to approach a certain service area to use a sharing service. For example, the fleet system may provide the moving object sharing service based on a device registered by the resident of the apartment or the worker of the office. Therefore, it is possible to provide the sharing service to only the specific target and to increase moving object security and management efficiency. However, the specific user who uses the shared moving object in the fleet system may be determined based on another method, and is not limited to the above-described embodiment.

In an embodiment of the present disclosure, a shared mobility may refer to a mobility which is authenticated or authorized to be shared by a system. For example, the shared mobility may be a vehicle registered in a management server. In addition, the management server may store and manage information necessary to provide a fleet service, such as mobility state information or mobility operation information of the registered mobility. In this case, the management server may monitor the state information of the shared mobility in real time through communication with the shared mobility and control usage rights or transmit a repair command to a mobility in which a problem occurs, through the system.

In addition, the management server may store and manage information on a user who uses the fleet service, that is, user information. The management server may provide an environment (web page or service application) in which user information may be registered, the user may provide the user information to the management server through the above-described environment, and the management server may register and store the user information.

In addition, the management server may perform a use authentication procedure, a security check procedure, etc. through communication with a device or a mobility, and provide information on a shared mobility to be used by a user to the device or mobility. In addition, the device may contact a vehicle to be used based on the information on the shared mobility.

For example, there may be a registered mobility and a registered device (or user) in the management server. That is, only specific mobilities and devices may be registered in the management server based on authentication and approval. In this case, the management server may operate based on the state information of the registered mobility and the registered device. For example, the management server may check information on a currently used mobility and location information of an individual mobility in real time. In this case, for example, each mobility may periodically transmit its own information to the management server. In addition, for example, each mobility may transmit its own information to the management server based on an event trigger. For example, when an event of changing a location of a mobility or changing whether to use a mobility is triggered, the mobility may transmit its own information to the management server.

In addition, the management server may check information on the registered device in real time. In this case, for example, the registered device may not always use a fleet system. Accordingly, the management server needs to store and manage whether the registered device uses the fleet service. In this case, for example, the management server may include list information of the registered device. A device which is currently using the mobility or activates the fleet service to use a vehicle among registered devices included in the list of the fleet service may be provided along with the list information. As another example, a registered device which does not use the fleet service (hereinafter referred to as a deactivated device), a registered device which uses a mobility through the fleet service (hereinafter referred to as an activated device) and a registered device which wants to use a mobility (hereinafter referred to as a temporary device) may be distinguishably displayed. That is, information indicating actual use, no intention to use or an intention to use but prior to use may be provided. In addition, for example, usage state information may be further indicated for the registered device which is using the mobility of the fleet service. For example, the usage state information may further include expected usage time information or usage location information.

More specifically, the management server may include and manage list information of a plurality of registered vehicles and a plurality of devices. In this case, the list information may include at least one of usage state information, device location information or mobility location information. In this case, the management server may provide a fleet service based on device location information and mobility location information. Here, the usage state information may include at least one of information on a mobility which is being used, expected time information of the mobility which is being used, device-mobility matching information, deactivated device information, activated device information, deactivated mobility information or activated mobility information. For example, the usage state information may further include information on a mobility which is currently being used by another device and expected time information of the mobility which is being used. In addition, the usage state information may further include device-mobility matching information based on list form information. In addition, the usage state information may include activated device information and deactivated device information. For example, the activated device information may indicate a device which is currently using the mobility or a device which is preparing for use among the registered devices, as described above. For example, the activated device may mean a device which executes a program or application for the fleet service. Meanwhile, the deactivated device may be a device which is registered in the management server but does not use mobility sharing. For example, the deactivated device may be a device which does not execute or deactivates a program or application for the fleet service.

In addition, the management server may include and manage activated mobility information and deactivated mobility information. In this case, for example, the management server may include and manage state information of a plurality of mobilities. In this case, the state information of the mobility may be information on the mobility such as information on abnormality of the mobility, information on the remaining driving distance, or refueling time information. That is, the state information of the mobility may be information for determining whether a mobility may be provided for mobility sharing and is not limited to the above-described embodiment. In this case, the management server may determine whether to activate the vehicle based on the above-described state information. For example, the management server may provide information to a mobility having a normal state and a sufficient amount of fuel as an activated vehicle. In contrast, when the state of the mobility is abnormal, the management server may classify the corresponding mobility as a deactivated mobility. In this case, the management server may provide information on the deactivated mobility to the device using a program or application for the fleet service. For example, the management server may repair or manage the deactivated mobility and is not limited to the above-described embodiment.

Meanwhile, a device which wants to use a mobility, that is, a temporary device, may want to use the mobility through the fleet service.

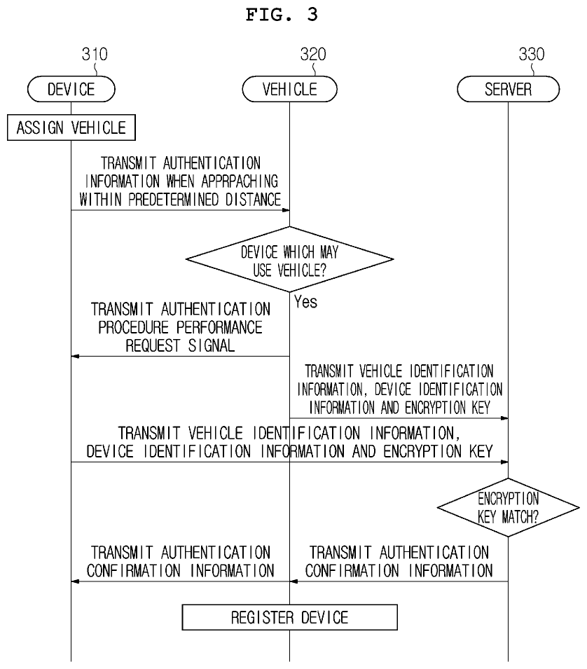

For example, referring to FIG. 3, a device 310 may execute a program or application for a fleet service and may be assigned a mobility (e.g., a vehicle) 320 to be used through communication with a management server 330 for providing a fleet service. In this case, the management server 330 may assign a specific mobility 320 to the device 310 using at least one of information on a mobility managed for the fleet service, location information of the mobility and location information of the device. For example, the management server 330 may assign only the mobility 320 located within a certain distance from the location of the device 310 and is not limited to the above-described embodiment. Meanwhile, when the mobility 320 cannot be assigned, the management server 330 may provide information on failure to use the fleet service to the device 310.

Next, when a user carries the device 310 and moves to a location where the mobility 320 is located, the device 310 may approach the mobility 320 within the predetermined distance. In response thereto, the device 310 may transmit an authentication signal to the mobility 320. In addition, the device 310 may use the shared mobility 320 through a tag for the shared mobility based on an available shared mobility list. For example, the device 310 may perform tagging for the mobility based on NFC, Bluetooth, or a magnetic stripe of a transportation card. In this case, when the device 310 is tagged, the shared vehicle 320 may perform an authentication procedure from the management server 330 such that the device 310 provides the mobility 320. For example, when authentication is completed based on the device tag, a door of the mobility 320 may be opened.

In relation to detailed operation for authentication, referring to FIG. 3, when the device 310 approaches the mobility 320 within the predetermined distance, an authentication signal may be transmitted to the mobility 320. In this case, communication which may be used by the mobility 320 and the device 310 may be Bluetooth, NFC or a tag as described above. That is, an authentication procedure may be performed under certain conditions, and is not limited to the above-described embodiment. When the device 310 approaches (tags) the corresponding vehicle, the corresponding vehicle and the device may determine whether the device 310 may use the mobility and perform authentication through signal exchange. In this case, the device 310 may transmit, to the vehicle, an authentication signal including its own identification information and identification information of a group including the device 310. In this case, the mobility 320 may determine whether the device 310 has been registered in a fleet system based on the identification information of the device 310 included in the received authentication information. In addition, the mobility 320 may determine whether the device 310 is included in a group, to which the mobility 320 may provide the service, based on the identification information of the group included in the authentication signal. That is, the mobility 320 may determine whether the device 310 may use the mobility 320 based on device identification information and group identification information. For example, when the device 310 may not use the mobility 320, the mobility 320 may transmit information on unavailability to the device 310 (not shown). For example, the device 310 may obtain information on unavailability from an application or other service provision program.

Meanwhile, when the device may use the mobility 320, the mobility 320 may transmit an authentication procedure performance request signal to the device 310. That is, when the device 310 is legally registered in the management server 330 and the mobility 320 also may legally operate based on the management server 330, the mobility 320 may transmit the authentication procedure performance request signal to the device 310. In this case, the mobility 320 may transmit its own identification information and encryption key information to the device 310 in the authentication procedure performance request signal. For example, both the identification information of the mobility and the device information may be registered in the fleet system. In this case, the mobility 320 may transmit a signal including vehicle identification information, device identification information and encryption key information to the management server 330.

In addition, the device 310 may also transmit, to the management server 330, the signal including the mobility identification information, the encryption key information and its own identification information included in the authentication procedure performance request signal.

Thereafter, the management server 330 may compare information included in the signal received from the mobility 320 and the signal received from the device 310. In this case, when all the identification information of the mobility 320, the device identification information and the encryption key information match, the management server 330 may recognize that the device 310 may use the mobility. Thereafter, the management server 330 may transmit authentication confirmation information to the mobility 320 and the device 310. In this case, the management server 330 may register information indicating that the device 310 uses the mobility 320 in a database. In addition, for example, the device 310 may also continuously transmit a time when the mobility 320 is used and additional information.

In addition, the mobility 320 may register the device based on the authentication confirmation information and open the door of the vehicle. In addition, a lock device for vehicle use may be unlocked and the device 310 may control the mobility.

In this case, for example, when authentication is completed, the mobility 320 and the device 310 may periodically exchange signals. That is, while the device 310 uses the mobility 320, the mobility 320 may perform continuous confirmation of use through periodic signal exchange with the device 310.

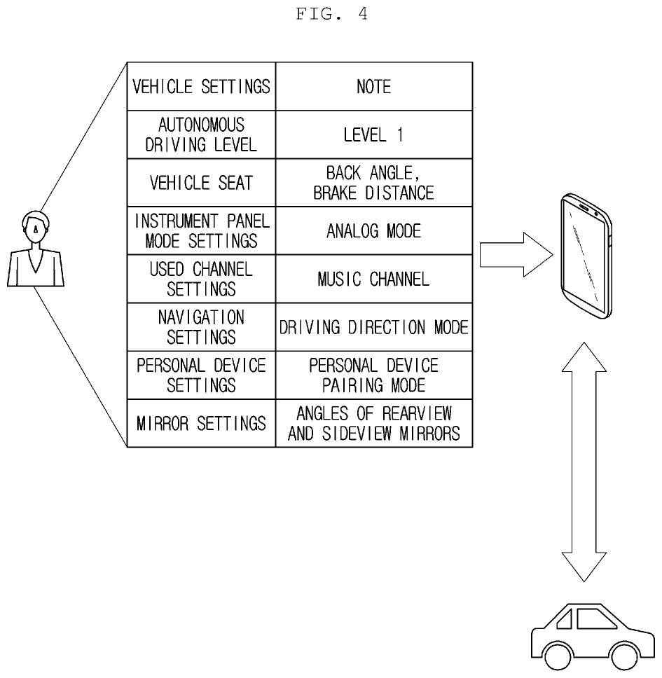

In this case, for example, referring to FIG. 4, the device may provide information on personal tendency (hereinafter referred to as personal tendency information) or user information to the mobility. Here, the personal tendency information or the user information may be stored in a storage medium provided in the device, a subscriber identification module (SIM) provided in the device or the mobility or the management server. In addition, the device may obtain the personal tendency information or the user information from the storage medium or SIM provided in the device or the management server if required. In addition, the mobility may check and store information set or input while each user uses the mobility and update and store the personal tendency information based on the information set or input by the user. Furthermore, the mobility may provide the updated personal tendency information to the device, and the device may store it in the storage medium, the SIM or the management server.

The personal tendency information may include autonomous driving level information or information on vehicle seat, instrument panel mode settings, used channel settings, navigation settings, personal device settings or mirror settings. However, this is only one example and is not limited to the above-described embodiment. That is, the mobility provided by the fleet service may learn the driving style of an individual and provide a personalized use environment. For example, as shown in FIG. 4, information set for a user may be converted into a user-customized form and provided. As a more specific example, various driving environments such as the location and height of a driver's seat, the color and brightness of interior lights, the location and angle of a rearview mirror and a sideview mirror, an in-vehicle temperature adjustment range (air conditioner and heater), a steering wheel angle, tire pressure, transmission setting mode (normal, eco, power mode, etc.), a wireless communication connection mode (WAVE, cellular, etc.), or an autonomous driving function setting variable range (speed and inter-vehicle distance, lane change transverse speed, acceleration, deceleration, etc.) may be changed and provided according to the driving style set in a user's personal device. In this case, for example, the management server may control settings of the mobility based on the above-described information, thereby increasing user convenience and accident prevention efficiency of the shared mobility. Specifically, settings for mobility operation may differ between users and, when each user uses a mobility having settings unsuitable therefor, accidents may increase due to inexperienced operation or the like. Accordingly, when the shared mobility is used, the risk of an accident may increase. In consideration of the foregoing, when the management server provides the sharing service through the shared mobility, mobility settings may be differently set through the above-described information based on the user's personal tendency.

The mobility may be designed such that settings may be changed based on the above-described information. As another example, as described above, a vehicle provided by the fleet service among shared vehicles may be configured such that settings considering personal tendency are controlled as described above. In contrast, when the personal mobility is shared, the above-described change may be limited for the purpose of vehicle security and design, and is not limited to the above-described embodiment. That is, when the shared mobility is provided through the fleet service, the fleet service may differently set levels for security and design change of the mobility based on the shared mobility information and increase user convenience based on this. That is, the device may set information on mobility operation. In this case, each user may set information for mobility use in advance in consideration of their driving habits or driving pattern. In this case, when the shared mobility is used, since the user uses a mobility which is not familiar to the user, the risk of an accident or vehicle operation errors may occur. In consideration of this point, centered on the device, the device may include setting information when the shared mobility is used.

In this case, for example, the device may check the provided shared mobility list and select a shared mobility. In this case, when the device approaches or contacts the shared mobility, the shared mobility may be used centered on the device. In this case, the settings for the shared mobility or other settings may be changed centered on the device such that the device user may use the shared mobility. In this case, the setting information of the mobility may change not only settings related to security and authentication but also content by reflecting the taste or tendency of the device user. For example, the form displayed on the shared mobility may be changed based on an interface set in the device, and operation may be performed based on this.

That is, as described above, when the device approaches the shared mobility, the shared mobility may be changed centered on the device and used.

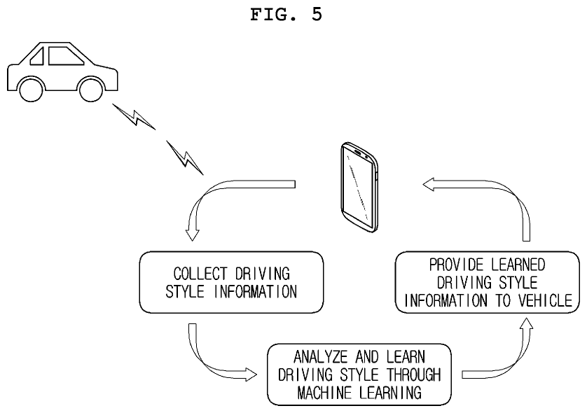

As another example, referring to FIG. 5, the above-described information may be information which is continuously learned based on machine learning. More specifically, personal tendency or driver information may be information set by the user based on FIG. 4. For example, the personal device of the user may collect information on driving style based on information on shared vehicle use. For example, the driver may adjust some settings according to convenience in a default setting state based on driving style information while using the shared mobility. In addition, the above-described settings may be changed in consideration of a specific context or a driving state during driving. In consideration of the foregoing, the personal device may collect mobility driving information or driving style information and continuously update setting information suitable for the user through machine learning.

Furthermore, the method of providing the mobility sharing service according to an embodiment of the present disclosure may control settings of the shared mobility using the driving style information of the user and, particularly, check various context information which may occur while operating the shared mobility and control the shared mobility according to the checked context information. Here, the context information may include at least one of driving environment information and user state information.

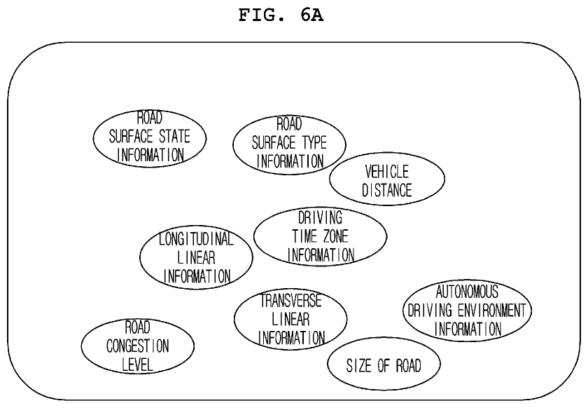

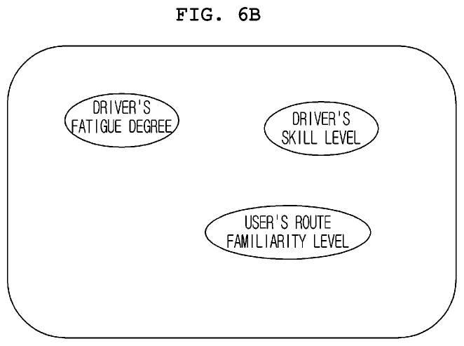

FIGS. 6A and 6B are views illustrating driving environment information and user state information used in a method of providing a mobility sharing service according to an embodiment of the present disclosure.

Referring to FIGS. 6A and 6B, specifically, driving environment information may include at least one of road surface type information, road surface state information, longitudinal linear information, transverse linear information, mobility (e.g., vehicle) distance, autonomous driving environment information, or driving time zone information. For example, the road surface type information may include information indicating a road surface, such as a paved road surface or an unpaved road surface. As another example, the road surface type information may include information indicating a material of the road surface, such as a concrete paved road surface or an asphalt paved road surface. The road surface type information may further include information indicating a material of the unpaved road surface, such as gravel or soil. The road surface state information may include information indicating the state of the road surface, such as whether the road surface is in a normal state, in a wet state, or in a frozen state. In addition, the road surface state information may further include information indicating whether a pothole is present in the road surface or the road surface is damaged. The longitudinal linear information includes linear information or gradient information of the road in the longitudinal direction, and may include, for example, information indicating a downhill road, an uphill road, or a flat road and may include information indicating an uphill slope and a downhill slope. The transverse linear information may include linear information of the road in the transverse direction and includes, for example, a radius of a curve and a gradient. The mobility distance may include information indicating a distance from a front mobility or a distance from a rear mobility. The autonomous driving environment information may include whether another mobility which is being driven around the mobility is autonomously driven and autonomous level information. The driving time zone information may include information indicating daytime and nighttime. As another example, the driving time zone information may be checked to be used as a criterion for determining a driver's fatigue degree. In consideration of this, it may be set in consideration of a time when the driver's fatigue degree is high. For example, the driving time zone information may include information indicating a time divided by a predetermined time (e.g., 1 hour).

Additionally, the driving environment information may further include a road congestion level. As another example, the driving environment information may further include the size of the road (e.g., narrow road, small road, middle road, large road, etc.).

As illustrated in FIG. 6B, the user state information may include at least one of a driver's fatigue degree, a driver's skill level, or a user's route familiarity level.

The driver's fatigue degree may be checked by analyzing a driver's bio signal and a driver's captured image. The driver's fatigue degree may vary according to the characteristics of an individual and may frequently vary during driving. Accordingly, the driver's fatigue degree is preferably configured based on the change value of the fatigue degree.

The driver's skill level may be determined in consideration of driver's driving experience, the number of times of using the vehicle, and a driving time. The driver's skill level may be calculated based on user information registered and managed by the management server or fleet service usage information or may be calculated based on the driver's driving experience or information received from another server apparatus for providing a driving time. The user's route familiarity level may include the number of times or amount of time the user travels along the corresponding route. Similarly, the user's route familiarity level may be calculated based on the user information registered and managed by the management server or fleet service usage information or may be calculated based on information received from the server apparatus for providing route guidance.

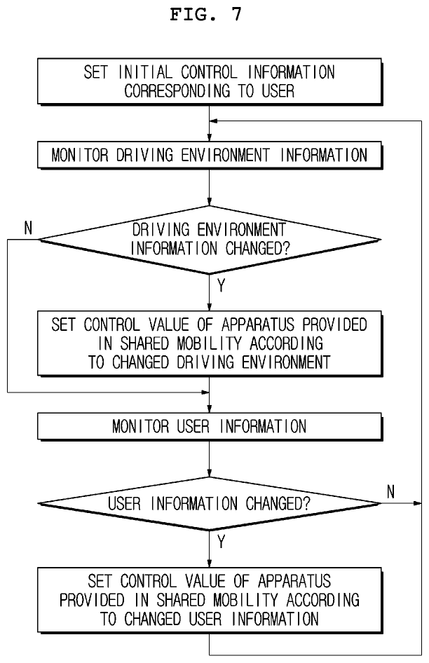

FIG. 7 is a flowchart illustrating a method of providing a mobility sharing service according to an embodiment of the present disclosure.

The method of providing the mobility sharing service may be performed by at least one of the shared mobility or the management server. Hereinafter, although, in this embodiment of the present disclosure, the method of providing the mobility sharing service is described as being performed by the shared mobility, the present disclosure is not limited thereto and an entity for performing the method of providing the mobility sharing service may be variously changed.

Referring to FIG. 7, first, the shared mobility may perform an operation of identifying the user of the mobility. Thereafter, the shared mobility may check initial control information suitable for the user and set an apparatus provided in the shared mobility according to the initial control information. Here, the initial control information may be stored in a storage medium or an apparatus storing user information or may be stored in the management server and may be obtained from the corresponding apparatus and provided to the shared mobility. Furthermore, the user of the mobility may include at least one of a driver or a passenger. In addition, the shared mobility may check the initial control information according to at least one of the driver or the passenger and set an apparatus provided in the shared mobility. For example, the shared mobility may provide the user with an environment (UI, etc.) capable of selecting the user as a criterion for setting the apparatus, that is, at least one of the driver or the passenger, and set a control value of the apparatus provided in the shared mobility according to the user received through the environment (UI, etc.), that is, at least one of the driver or the passenger.

Although, in an embodiment of the present disclosure, operation of receiving the user as a criterion for setting the apparatus through the environment (UI, etc.) capable of selecting the user, that is, at least one of the driver or the passenger, is performed, the present disclosure is not limited thereto and various modifications are applicable. For example, the shared mobility may identify the driver and the passenger who ride in the mobility and determine at least one of the driver or the passenger to be a user as a criterion for setting by a predetermined condition or rule.

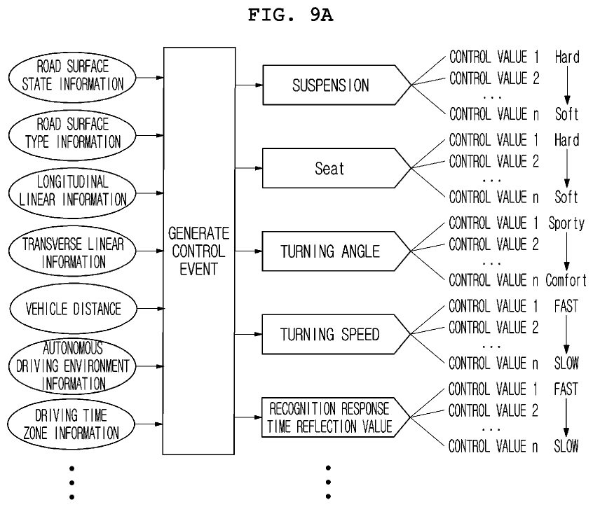

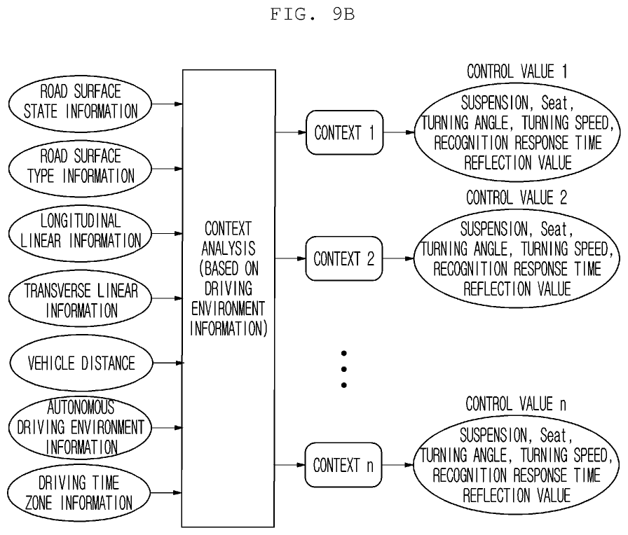

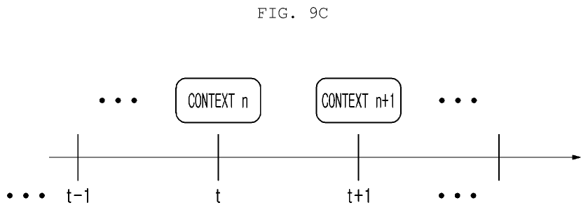

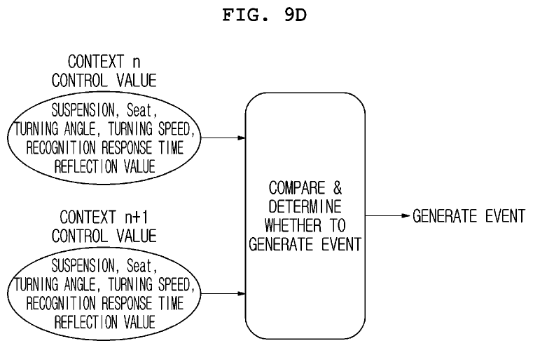

Thereafter, the shared mobility may monitor driving environment information and may check whether a driving environment change event occurs using the monitored driving environment information. Whether the driving environment change event occurs will be described in detail below with reference to FIGS. 9A to 9D. Here, initial driving environment information checked by the shared mobility may include at least one of road surface type information, road surface state information, driving time zone information, a road congestion level, or the size of the road. The above-described initial driving environment information may be checked based on information obtained through an electronic map (HD map), a camera, a radar, a LiDAR, etc.

Meanwhile, when a driving environment change event occurs, the shared mobility may set the control value of the apparatus provided in the shared mobility according to the changed event and control the corresponding apparatus based on this.

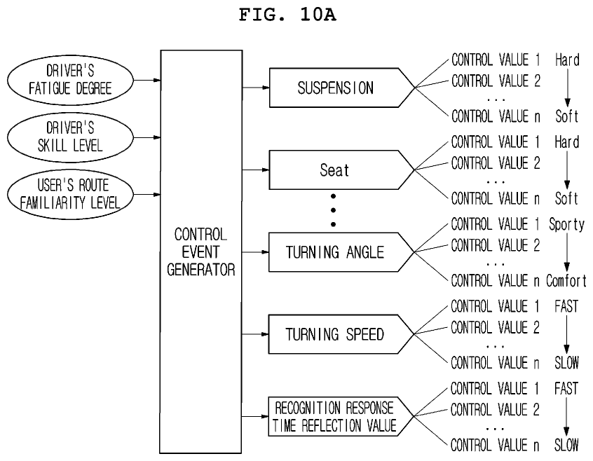

In contrast, when the driving environment change event does not occur, the shared mobility may monitor user information and set and control the control value of the apparatus provided in the mobility using the monitored user information to perform control. In this case, the shared mobility may check whether a user information change event occurs. Whether the user information change event occurs will be described in detail below with reference to FIGS. 10A and 10B. When the user information change event occurs, the shared mobility may set the control value of the apparatus provided in the shared mobility according to the changed event and control the apparatus based on this. In contrast, when the user information event does not occur, the shared mobility may perform operation by returning to operation of monitoring the driving environment information.

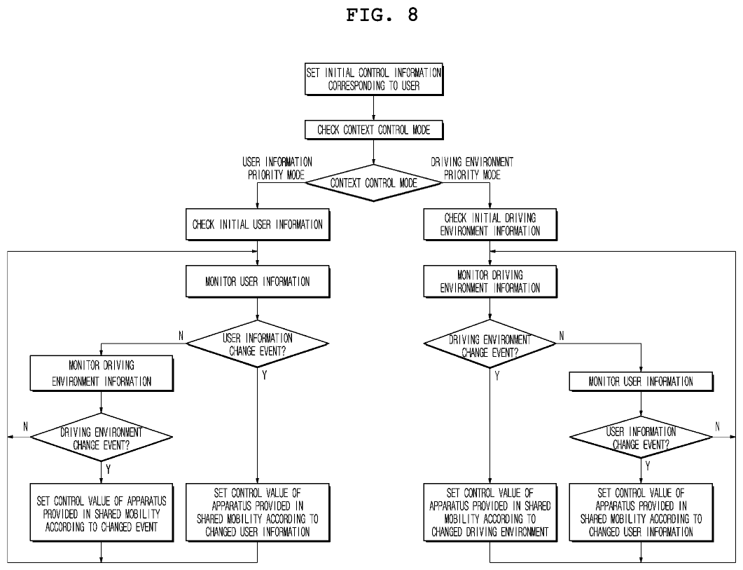

FIG. 8 is a flowchart illustrating a method of providing a mobility sharing service according to another embodiment of the present disclosure.

The method of providing the mobility sharing service may be performed by at least one of the shared mobility or the management server. Hereinafter, although the method of providing the mobility sharing service is described as being by the shared mobility, the present disclosure is not limited thereto and an entity for performing the method of providing the mobility sharing service may be variously changed.

Referring to FIG. 8, first, the shared mobility may perform an operation of identifying the user of the mobility. Thereafter, the shared mobility may check initial control information suitable for the user and set an apparatus provided in the shared mobility according to the initial control information. Here, the initial control information may be stored in a storage medium or an apparatus storing user information or may be stored in the management server and may be obtained from the corresponding apparatus and provided to the shared mobility.

Thereafter, the shared mobility may check a context control mode. Here, the context control mode may include a driving environment priority mode or a user information priority mode. It may be set based on a fleet service usage history of a user who uses the shared mobility. For example, when the driving environment priority mode is used more than the user information priority mode in the fleet service use history, the shared mobility may determine the context control mode to be the driving environment priority mode. As another example, the shared mobility provides the user with an environment (UI, etc.) capable of selecting a context control mode, and receive and determine the context control mode from the user through the environment (UI, etc.) capable of selecting the context control mode. Although, in an embodiment of the present disclosure, a method of selecting the context control mode is described, the present disclosure is not limited thereto and the method of selecting the context control mode may be variously changed.

When the driving environment priority mode is determined, the shared mobility may check the initial driving environment information and set an apparatus provided in the shared mobility according to a control value preferred by the user. In this case, the initial driving environment information checked by the shared mobility may include at least one of road surface type information, road surface state information, driving time zone information, a road congestion level or the size of the road. The above-described initial driving environment information may be checked based on information obtained through an electronic map (HD map), a camera, a radar, a LiDAR, etc.

Thereafter, the shared mobility may monitor driving environment information and may check whether a driving environment change event occurs using the monitored driving environment information. Whether the driving environment change event occurs will be described in detail below with reference to FIGS. 9A to 9D.

Meanwhile, when a driving environment change event occurs, the shared mobility may set the control value of the apparatus provided in the shared mobility according to the changed event and control the corresponding apparatus based on this.

In contrast, when the driving environment change event does not occur, the shared mobility may monitor user information and set and control the control value of the apparatus provided in the mobility using the monitored user information to perform control. In this case, the shared mobility may check whether a user information change event occurs. Whether the user information change event occurs will be described in detail below with reference to FIGS. 9A and 9B. When the user information change event occurs, the shared mobility may set the control value of the apparatus provided in the shared mobility according to the changed event and control the apparatus based on this.

In contrast, when the user information event does not occur, the shared mobility may perform an operation by returning to the operation of monitoring the driving environment information.

When the user information mode is determined, the shared mobility may check initial user information and set the apparatus provided in the mobility according to a control value preferred by the user. In this case, the initial user information checked by the shared mobility may include at least one of the driver's fatigue degree, the driver's skill level, or the user's route familiarity level. The initial user information may be checked based on information obtained through an electronic map (HD map), an internal camera of the vehicle, a bio information detection device, etc.

Thereafter, the shared mobility may monitor the user information and check whether a user information change event occurs using the monitored user information. Whether the user change event occurs will be described in detail below with reference to FIGS. 9A and 9B.

Meanwhile, when the user information change event occurs, the shared mobility may set the control value of the apparatus provided in the shared mobility according to the changed event and control the apparatus based on this.

In contrast, when the user information change event does not occur, the shared mobility may monitor driving environment information and check whether a driving environment change event occurs using the monitored driving environment information. Whether the driving environment change event occurs will be described in detail below with reference to FIGS. 9A and 9D. When the driving environment change event occurs, the shared mobility may set the control value of the apparatus provided in the shared mobility according to the changed event and control the apparatus based on this.

In contrast, when the driving environment change event does not occur, the shared mobility may perform an operation by returning to the operation of monitoring the driving environment information.

FIGS. 9A to 9D are views illustrating operation of generating a driving environment change event in a method of providing a mobility sharing service according to an embodiment of the present disclosure.

FIG. 9A shows operation of outputting control information using driving environment information. The shared mobility may set the control value of the apparatus provided in the mobility, such as suspension, seat type, turning angle, turning speed, or recognition response time reflection value. In this case, the shared mobility may generate a control event and control the control value of the apparatus provided in the mobility according to each control event.

For example, the shared mobility may analyze context using various information (e.g., road surface type information, road surface state information, longitudinal linear information, transverse linear information, mobility distance, autonomous driving environment information, or driving time zone information) included in the driving environment information (see FIG. 9B). In addition, the shared mobility may set the control value (e.g., suspension, seat type, turning angle, turning speed, or recognition response time reflection value) of the apparatus suitable for each context. Thereafter, the shared mobility may detect the context every predetermined time unit (see FIG. 9C), compare the control values of detected contexts, and generate a driving environment change event (see FIG. 9D). For example, even if the context is detected every predetermined time unit, the control values of the contexts may be equally configured. In consideration of this, the shared mobility is configured to not generate a driving environment change event when the control values of the contexts are the same and to generate the driving environment change event when the control values of the contexts are not the same.

FIGS. 10A and 10B are views illustrating an operation of generating a user information change event in a method of providing a mobility sharing service according to an embodiment of the present disclosure.

FIG. 10A shows an operation of outputting control information using user information. The shared mobility may set the control value of the apparatus provided in the mobility, such as suspension, seat type, turning angle, turning speed, or recognition response time reflection value. In this case, the shared mobility may generate a control event and control the control value of the apparatus provided in the mobility according to each control event.

For example, the shared mobility may analyze context using various information (e.g., a driver's fatigue degree, a driver's skill level, or a user's route familiarity level) included in the user information (see FIG. 10B). In addition, the shared mobility may set the control value (e.g., suspension, seat type, turning angle, turning speed, or recognition response time reflection value) of the apparatus suitable for each context. Thereafter, the shared mobility may detect contexts every predetermined time unit, compare the control values for detected contexts and generate a user information change event. For example, even if the context is detected every predetermined time unit, the control values of the contexts may be equally configured. In consideration of this, similarly to the driving environment change event, the shared mobility is configured to not generate a driving environment change event when the control values of the contexts are the same and to generate the driving environment change event when the control values of the contexts are not the same.

Additionally, the driver's fatigue degree may be checked by analyzing a driver's bio signal and a driver's captured image. The driver's fatigue degree may vary according to the characteristics of an individual. Accordingly, the driver's fatigue degree is preferably checked based on the change value of the fatigue degree. For example, the shared mobility may check an initial fatigue degree by analyzing a bio signal or an image when the user starts driving, and check a driving fatigue degree while the shared mobility is driven. In addition, the shared mobility may check a change value between the initial fatigue degree and the driving fatigue degree or a change value between driving fatigue degrees and analyze context based on the change value between the initial fatigue degree and the driving fatigue degree or the change value between driving fatigue degrees. Here, the change value may include a change amount or a change rate.

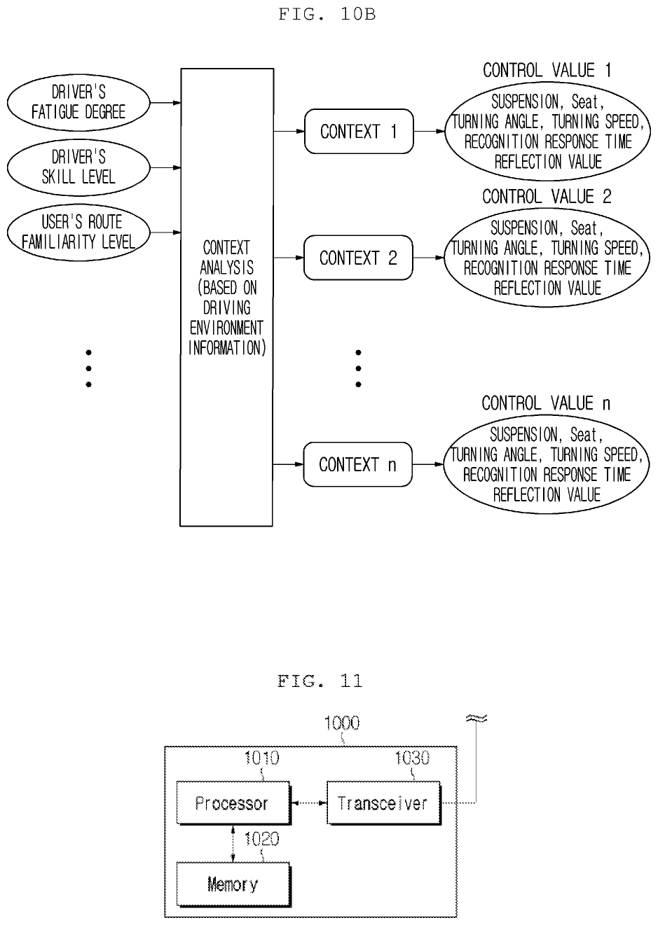

FIG. 11 is a view illustrating the configuration of an apparatus according to an embodiment of the present disclosure.

Referring to FIG. 11, the apparatus may include at least one of the above-described moving object, device, server or RSU. That is, the apparatus may perform communication with another device and may be linked to another device, and is not limited to the above-described embodiment. For example, the apparatus 1000 may include at least one of a processor 1010, a memory 1020 or a transceiver 1030 for the above-described operation. That is, the apparatus may include components necessary to perform communication with another device. In addition, for example, the apparatus may include components other than the above-described components. That is, the apparatus includes the above-described components to perform communication with another device, but is not limited thereto, and may operate based on the above description.

While the exemplary methods of embodiments of the present disclosure described above are represented as a series of operations for clarity of description, it is not intended to limit the order in which the steps are performed, and the steps may be performed simultaneously or in a different order as necessary. In order to implement the method according to embodiments of the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing embodiments of the present invention by hardware, embodiments of the present disclosure can be implemented with application specific integrated circuits (ASICs), digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. A method of providing a mobility sharing service, the method comprising:
generating initial control information of a mobility in correspondence with an identified user;
monitoring driving environment information;
generating a driving environment change event based on the driving environment information; and
generating control information of the mobility based on the driving environment change event.

2. The method of claim 1, further comprising:
monitoring user information of the identified user; and
generating a user information change event based on the user information.

3. The method of claim 2, wherein generating the control information of the mobility comprises generating the control information of the mobility based the driving environment change event or the user information change event.

4. The method of claim 2, further comprising checking a context control mode.

5. The method of claim 4, wherein the context control mode comprises a driving environment priority mode in which control is performed by preferentially considering the driving environment information or a user information priority mode in which control is performed by preferentially considering the user information.

6. The method of claim 5, wherein monitoring the driving environment information is performed in response to determining that the context control mode is the driving environment priority mode.

7. The method of claim 6, wherein the control information of the mobility is generated in response to the driving environment change event being generated based on the driving environment information.

8. The method of claim 7, wherein monitoring the user information is performed in response to the driving environment change event not being generated based on the driving environment information.

9. The method of claim 8, wherein the control information of the mobility is generated in response to the user information change event being generated based on the user information.

10. The method of claim 5, wherein monitoring the user information is preferentially performed in response to determining that the context control mode is the user information priority mode.

11. The method of claim 10, wherein the control information of the mobility is generated in response to the user information change event being generated based on the user information.

12. The method of claim 11, wherein monitoring the driving environment information is performed in response to the user information change event not being generated based on the user information.

13. The method of claim 12, wherein the control information of the mobility is generated in response to the driving environment change event being generated based on the driving environment information.

14. The method of claim 2, wherein generating the user information change event comprises:
checking a first control value corresponding to a first context;
checking a second control value corresponding to a second context;
comparing the first control value with the second control value; and
generating the user information change event according to a result of comparing the first control value with the second control value.

15. The method of claim 2, wherein monitoring the user information comprises:
checking an initial fatigue degree when the identified user starts driving; and
checking a subsequent driving fatigue degree while the mobility is driven.

16. The method of claim 15, wherein monitoring the user information comprises checking a change value between the initial fatigue degree and the subsequent driving fatigue degree or checking a change value between the subsequent driving fatigue degree and another subsequent driving fatigue degree.

17. The method of claim 1, wherein generating the driving environment change event comprises:
checking a first control value corresponding to a first context;
checking a second control value corresponding to a second context;
comparing the first control value with the second control value; and
generating the driving environment change event according to a result of comparing the first control value with the second control value.

18. The method of claim 1, wherein the driving environment information comprises road surface type information, road surface state information, longitudinal linear information, transverse linear information, mobility distance, autonomous driving environment information, driving time zone information, a road congestion level, or size information of a road.

19. A mobility comprising:
a communication unit;
a storage medium; and
a processor configured to:
receive initial control information corresponding to an identified user from a server apparatus;
monitor driving environment information;
generate a driving environment change event based on the driving environment information;
generate control information of the mobility based on the driving environment change event; and
control the mobility based on the control information.

20. A server apparatus comprising:
a communication unit;
a storage medium; and
a processor configured to:
manage user information for a plurality of users of a mobility sharing service;
identify a user among the plurality of users currently requesting to use the mobility sharing service;
check initial control information of the identified user; and
provide the initial control information to a mobility.
